(19) United States
(12) Patent Application Publication
(10) Pub. No.: US 2014/0200170 A1
(43) Pub. Date: Jul. 17, 2014

(54) General purpose vehicle detail cleaning solution

(71) Applicants: James Coe, JR., Springdale, MD (US); James Hampton Coe, III, Springdale, MD (US)

(72) Inventors: James Coe, JR., Springdale, MD (US); James Hampton Coe, III, Springdale, MD (US)

(21) Appl. No.: 14/154,044

(22) Filed: Jan. 13, 2014

Related U.S. Application Data
(60) Provisional application No. 61/752,165, filed on Jan. 14, 2013.

(51) Int. Cl. C11D 3/00

(52) U.S. Cl. CPC C11D 3/0036
USPC 510/241

(57) ABSTRACT

A general purpose detail cleaning solution contains a blend of chemicals in one solution to remove water spots, swirls, dust and fingerprints in existing waxes, polishes and sealants, and revitalize paint. The solution will preferably be available in both squeeze bottles and spray bottles. The user sprays one section of the vehicle at a time, and gently spreads the solution over the entire surface of the vehicle section using a folded microfiber towel. The user then flips over the microfiber towel to reveal a dry section of the towel, and buffs the vehicle section until it is dry. This process is repeated until the entire vehicle has been detail cleaned.

### CROSS-REFERENCE TO RELATED APPLICATIONS

This Application Claims priority to U.S. Provisional Application No. 61/752,165, filed Jan. 14, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vehicle detail cleaning solutions, and in particular to a general purpose detail cleaning solution that removes water spots, swirls, dust and fingerprints in existing waxes, polishes and sealants, and revitalizes paint. Vehicle owners and used vehicle dealers often purchase multiple products to clean, restore, and revitalize the external surfaces of their vehicles, in a process known as detail cleaning. The general purpose detail cleaning solution enables the user to detail clean vehicles using only one product.

### SUMMARY OF THE INVENTION

Accordingly, the invention is directed to a general purpose detail cleaning solution that contains a blend of chemicals in one solution to remove water spots, swirls, dust and fingerprints in existing waxes, polishes and sealants, and revitalize paint. The solution will preferably be available in both squeeze bottles and spray bottles. The user sprays one section of the vehicle at a time, and gently spreads the solution over the entire surface of the vehicle section using a folded microfiber towel. The user then flips over the microfiber towel to reveal a dry section of the towel, and buffs the vehicle section until it is dry. This process is repeated until the entire vehicle has been detail cleaned.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

No drawing is provided for the disclosed invention because a drawing is not necessary for the understanding of the invention under 35 U.S.C. §113, 37 C.F.R. §1.81(a), and MPEP §608.02 (III) (B).

### DETAILED DESCRIPTION OF THE INVENTION

Referring now to the invention in more detail, the invention is directed to a cleaning solution for use in detail cleaning exterior surfaces of vehicles. The solution preferably contains a blend of chemicals in one solution to remove water spots, swirls, dust and fingerprints in existing waxes, polishes and sealants, and revitalize paint. The solution will preferably be available in both squeeze bottles and spray bottles and will arrive to the user as a pre-mixed product. The user sprays one section of the vehicle at a time, and gently spreads the solution over the entire surface of the vehicle section using a folded microfiber towel. The user then flips over the microfiber towel to reveal a dry section of the towel, and buffs the vehicle section until it is dry. This process is repeated until the entire vehicle has been detail cleaned.

In an exemplary concentration, the solution preferably contains one ounce of finish polish (for example, NU Finish Polish™), five ounces of tire spray (for example, Meguiars™ endurance tire spray), five ounces of nano glaze (for example, Surf City Garage™ nano glaze), two ounces of nano seal (for example, Surf City™ glaze nano seal), two ounces of spray buff (for example, Baltimore Supply™ shine spray buff), and three ounces of synthetic wax (for example, Mothers™ synthetic wax). The exemplary quantities are given as fluid ounces of an 18 fluid ounce total volume; equivalent concentrations over different volumes are equally preferable.

The finish polish is preferably composed of petroleum distillate, six to twelve percent weight by volume, one hundred parts per million; ceramic microspheres, three to ten percent by volume, one hundred parts per million; and oleic diethanol amide, one to five percent by volume, two hundred parts per million.

The tire spray is preferably composed of isobutyrate, one half to two percent weight by volume; phenylenediamino triazine, one tenth to one percent weight by volume; aliphatic glycol acetate, one to five percent weight by volume; and hydrotreated distillate, ten to thirty percent weight by volume.

The nano glaze is preferably composed of naphtha(petroleum), hydrotreated heavy, ten to fifteen percent weight by volume; octamethylcyclotetrasiloxane, five to eight percent weight by volume; and decamethylcyclopentasiloxane, one to three percent weight by volume.

The nano seal is preferably composed of mineral spirits aliphatics, five to ten percent weight by volume; octamethylcyclotetrasiloxane, five to ten percent weight by volume; amino-alkoxy dimethylsiloxane, less than two percent weight by volume; decamethylcyclopentasiloxane, less than two percent weight by volume; distillates (petroleum), hydrotreated light, less than two percent weight by volume; and alcohol, denatured, less than or equal to one percent weight by volume.

The spray buff is preferably composed of C 12-14 Isoalkanes, fifty to seventy percent weigh by volume.

The synthetic wax is preferably composed of naphtha (petroleum), heavy alkylate, ten to less than thirty percent weight by volume; calcined kaolin clay, ten to less than thirty percent weight by volume; ispropyl alcohol, less than ten percent weight by volume; D-Limonene, less than ten percent by volume; and oleamide dea, less than ten percent by volume.

The solution is preferably applied after each vehicle washing to refresh existing wax, polish, or sealant, and combines the protective features of sealants and the shine of waxes. The solution removes any imperfection in existing vehicle waxes, polishes, and sealants. The solution is safe for use on wheel rims, and removes haze from yellow headlights. The solution will preferably be blended so that it can be used more than once a day without harming the exterior surface of the vehicle.

Components listed are preferable, but artisans will recognize that alternate components could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A composition for detail cleaning of vehicles comprising:
(a) a finish polish component, said finish polish component being a part of a plurality of components;
(b) a tire spray component, said tire spray component being a part of said plurality of components;
(c) a nano glaze component, said nano glaze component being a part of said plurality of components;
(d) a nano seal component, said nano seal component being a part of said plurality of components;
(e) a spray buff component, said spray buff component being a part of said plurality of components;
(f) a synthetic wax component, said synthetic wax component being a part of said plurality of components; and
(g) said plurality of components being combined into a solution.

2. The composition for detail cleaning of vehicles of claim 1 wherein said plurality of components are relatively concentrated about equivalently to the following proportions of an 18-ounce total volume:
(a) said finish polish component comprising 1 ounce of said 18-ounce total volume;
(b) said tire spray component comprising 5 ounces of said 18-ounce total volume;
(c) said nano glaze component comprising 5 ounces of said 18-ounce total volume;
(d) said nano seal component comprising 2 ounces of said 18-ounce total volume;
(e) said spray buff component comprising 2 ounces of said 18-ounce total volume;
(f) said synthetic wax component comprising 3 ounces of said 18-ounce total volume.

3. The composition for detail cleaning of vehicles of claim 1 wherein said solution is provided in a squeeze-bottle.

4. The composition for detail cleaning of vehicles of claim 2 wherein said solution is provided in a squeeze-bottle.

5. The composition for detail cleaning of vehicles of claim 1 wherein said solution is provided in a spray bottle.

6. The composition for detail cleaning of vehicles of claim 2 wherein said solution is provided in a spray bottle.
